(19) United States
(12) Patent Application Publication
(10) Pub. No.: US 2008/0057398 A1
(43) Pub. Date: Mar. 6, 2008

(54) Non-faraday based systems, devices and methods for removing ionic species from liquid

(75) Inventors: Chang Wei, Niskayuna, NY (US); Yu Du, Shanghai (CN); Wei Cai, Shanghai (CN); Rihua Xiong, Shanghai (CN); Lei Cao, Shanghai (CN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, New York, NY (US)

(21) Appl. No.: 11/515,653

(22) Filed: Sep. 6, 2006

(51) Int. Cl. H01M 4/02; B32B 15/04; C25B 11/00

(52) U.S. Cl. 429/218.1; 204/280; 428/411.1; 428/457; 429/209

(57) ABSTRACT

A non-Faraday ionic species removal process and system is described. The system includes a power supply, a pump for transporting a liquid through the system, and a plurality of porous electrodes. The electrodes, each include an electrically conductive porous portion. The electrodes may also include a substrate contiguous with the porous portion. The porous electrode can be utilized in electrodialysis and electrodialysis reversal systems. A method for forming a porous electrode is described.

### BACKGROUND

The invention relates generally to systems and devices for the removal of ionic species from fluid, and more particularly to electrodialysis and/or electrodialysis reversal systems, devices and methods that utilize non-Faraday electrodes.

The use of electrodialysis to separate ionic species in solutions is known. See, for example, U.S. Pat. No. 4,539,091. Essentially, known electrodialysis methods for separating ionic species in solutions involve the alternate arrangement of cation exchange membranes, for selectively passing cations, and anion exchange membranes, for selectively passing anions, between a pair of electrodes. A direct current being passed between the electrodes causes cations to be transferred toward the negative electrode and anions to be transferred toward the positive electrode. These ions are selectively passed through the ion exchange membranes. Dilution tanks and concentrate tanks are positioned to take up the separated portions of the ionic solutions.

Electrodialysis (ED) has been known commercially since the early 1960s. Known electrodialysis methodologies depend on the general principles of (1) most salts dissolved in water are ionic, being positively (cationic) or negatively (anionic) charged; (2) such ions are attracted to electrodes with an opposite electric charge; and (3) membranes can be constructed to permit selective passage of either anions or cations.

The dissolved ionic constituents in an ionic solution such as Na⁺, Ca²⁺, and CO₃²⁻ are dispersed in water, effectively neutralizing their individual charges. When electrodes connected to an outside source of direct current, such as a battery, are put in a circuit including saline water, electrical current travels the saline water, and the ions tend to migrate to the electrode with the opposite charge. For example, and with specific reference to FIG. 1, an electrodialysis system 10 is shown including a cathode 12 and an anode 24. Further, the system 10 includes a first cation-transfer membrane 14, an anion-transfer membrane 18, a second cation-transfer membrane 22, and a direct current source 26. Upon closing of the circuit including the source 26, the cation 12, and the anion 24, the sodium ions (Na⁺) migrate toward the cathode 12, while the chlorine ions (Cl⁻) migrate toward the anode 24. This migration leads to a separation of a single input stream of impaired water into a demineralized product stream 16 and a concentrate stream 20.

The technique of electrodialysis reversal (EDR) has been known since the early 1970s. EDR systems operate on the same general principle as a standard electrodialysis system, except that the electrical polarity of EDR is reversed frequently. At intervals of several times an hour, the polarity of the electrodes is reversed, and the flows are simultaneously switched so that the brine channel becomes the product water channel, and the product water channel becomes the brine channel. The rationale for this reversal is that by alternating the brine channel and the product channel (containing dilute water) over time the product channel. The reversal process is useful in breaking up and flushing out scales, slimes and other deposits in the cells before they can build up and create a problem. Flushing allows the unit to operate with fewer pretreatment chemicals minimizes membrane fouling.

Known electrodialysis systems and methods for seawater involve the use of Faraday reactions. Faraday reactions are the reactions that take place between electrodes and the electrolytes in electric and electrolytic cells or the reactions that take place in an electrolyte as electricity passes through it. One of the important characteristics is that it is an electron transfer process. An electron transfer reaction consists of a reduction reaction and an oxidation reaction that happen at either of the electrodes. A chemical species is called reduced when it gains electrons through a reduction reaction, and is oxidized when it loses electrons through an oxidation reaction. Examples of Faraday reactions are provided below. For example, species B is oxidized to A in the reaction shown below,

B⁻=A+e⁻;

where B⁻ is a substance in its reductive state and A is the substance in its oxidative state. Other examples include:

2Cl⁻=Cl₂+2e⁻; and

2H⁺+2e⁻=H₂.

Disadvantages of known ED and EDR systems include the complexity of the system designs, the amount of scaling and fouling that occurs within the system, especially the membranes, and a low electrode life due to the corrosion stemming from the Faraday reactions. Specifically, the chlorine in the salt water causes corrosion, particularly corrosion of membranes, lowering their effective life. Additionally, the gas evolution, oxygen at the anode and hydrogen at the cathode, requires the need for degassifiers, increasing the complexity and cost of desalinization plants utilizing ED and/or EDR technology.

### BRIEF DESCRIPTION

The invention includes embodiments that relate to an ionic species removal system that includes a power supply, a pump for transporting a liquid through the system, and a plurality of porous electrodes. Each of the porous electrodes includes an electrically conductive porous portion.

The invention includes embodiments that relate to a method for forming a porous electrode. The method includes forming a slurry including electrode materials, and coating the slurry on a substrate.

The invention includes embodiments that relate to a porous electrode that includes an electrically conductive porous portion having a surface area in a range of 10-10000 m²/g.

These and other advantages and features will be more readily understood from the following detailed description of preferred embodiments of the invention that is provided in connection with the accompanying drawings.

### BRIEF DESCRIPTION OF THE DRAWINGS

FIG. 1 is a schematic view of a known electrodialysis methodology.

FIG. 2 is a schematic view of an electrodialysis system constructed in accordance with an embodiment of the invention.

FIG. 3 is a schematic view of the electrical flow in the electrodialysis system of FIG. 2.

FIG. 4 is a schematic view of a porous electrode constructed in accordance with an embodiment of the invention.

FIG. 5 is a schematic view of an electrodialysis reversal system constructed in accordance with an embodiment of the invention.

FIG. 6 illustrates process steps for forming a porous carbon electrode in accordance with an embodiment of the invention.

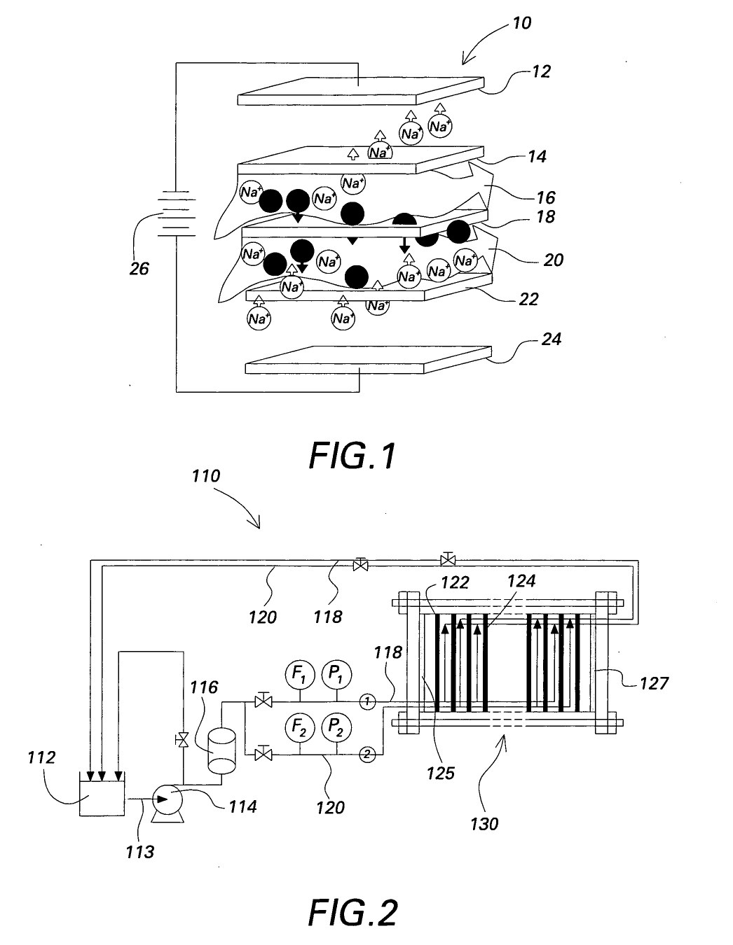

### DETAILED DESCRIPTION

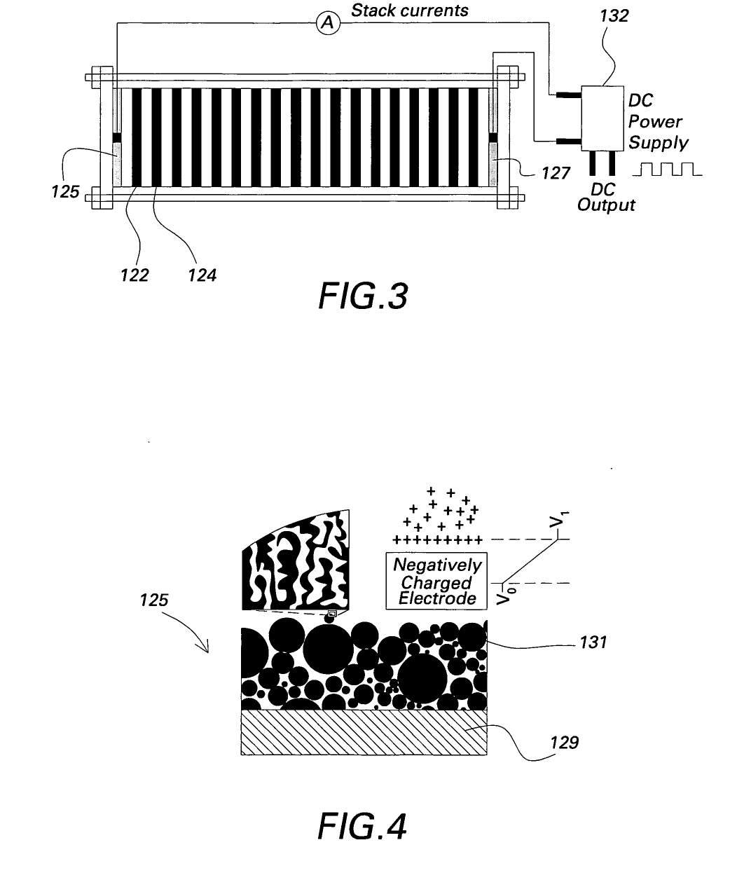

FIGS. 2 and 3 describe an ionic species removal system in accordance with embodiments of the invention. Referring to FIGS. 2 and 3, there is shown an ED system 110 for removing ionic species from a liquid that includes feed tanks 112, a feed pump 114, a filter 116, and a membrane stack 130. The liquid from which the ionic species is being removed may be, for example, impaired water supplies that may be encountered in numerous applications, such as, for example, water purification, wastewater treatment, and mineral removal. In addition, applicable industries in which liquids may require ionic species removal include but are not limited to water and processes, pharmaceuticals, and food and beverage industries. Although embodiments of ionic species removal systems described herein, such as the ED system 110, may be utilized for any application in which ionic species is to be removed from a liquid, for exemplary purposes only the ED system 110 will be described in terms of a water purification system, such as, for example, a desalination system. The membrane stack 130 includes alternating cation-transfer membranes 122 and anion-transfer membranes 124, as well as a porous negative electrode 125 and a porous positive electrode 127. Liquid, such as impaired water like saline water, is transferred from the feed water tanks 112 by an input line 113 to the feed pump 114, which pumps the saline water through the filter 116. The filter serves to prevent small particles that may be present in the feed water from entering the membrane stack and fouling or blocking the stack. The filtered saline water is then divided into a dilute stream line 118 and a concentrate stream line 120. By separating the saline water into the two stream lines 118, 120, separate control of the flow rates of the two streams is enabled. Both of the stream lines 118, 120 are passed through the membrane stack 130, allowing further separation of concentrate into the concentrate stream line 120.

As direct current power from a DC power supply 132 (FIG. 3) is passed through the electrodes 125, 127, the cations and anions migrate to opposing electrodes, thereby causing a separation of the saline water into concentrate and dilute stream lines. It should be appreciated that although a DC power supply is shown in FIG. 3, an alternative power supply may be used. For example, instead of DC power supply 132, an AC power supply, a DC power supply having a pulsed current with a short duration, or an AC power supply having a pulsed current with a short duration may be used. Under the direct current from the DC power supply 132, the cations in the dilute chambers migrate towards the negative electrode 125 and pass through the cation exchange membranes 122 to the concentrate chambers near the negative electrode 125, while the anions in the dilute chambers migrate towards the positive electrode 127 and pass through the anion exchange membranes 124 to concentrate chambers near the positive electrode 127. By this means, the feed water in the dilute chambers is desalinated, which forms the so-called dilute stream. Meanwhile, in the concentrate chambers, the anions and cations also tend to migrate toward opposing electrodes, but these migrations are blocked by the membranes with opposing ion exchange capabilities. That is to say, the ions can only migrate from the dilute chambers to the concentrate chambers and cannot migrate from concentrate chambers to dilute chambers. So the concentration of the feed water in the concentrate chambers is increased, which is the reason why the concentrate stream forms.

Known ED and EDR systems utilize Faraday reactions, which are oxidation or reduction processes. The non-Faraday process described with reference to embodiments of the invention is an electrostatic process, where there is no electron transfer in the process. To effectively utilize non-Faraday processes in an ED and/or EDR system, it is necessary that a low voltage be used or a high surface area for the electrodes be employed. This necessity is shown in the following charge-voltage equation:

q=cv,

where q is the charge, c is the capacitance, and v is the voltage. According to this equation, if the capacitance is large then the voltage is minimized, and conversely if the capacitance is small then the voltage is maximized.

With particular reference to FIG. 4, next will be described high-surface area porous electrodes, such as electrodes 125, 127. The porous electrodes 125, 127 include a substrate 129 and a porous portion 131. The substrate 129 may be formed of any suitable metallic structure, such as, for example, a plate, a mesh, a foil, or a sheet. Furthermore, the substrate 129 may be formed of suitable conductive materials, such as, for example, stainless steel, graphite, titanium, platinum, iridium, rhodium, or conductive plastic. In addition, the metals may be uncoated or coated. One such example is a platinum coated stainless steel mesh. In one embodiment, the substrate 129 is a titanium mesh. In other embodiments, the substrate 129 is a stainless steel mesh, a graphite plate, or a titanium plate.

The porous portion may be formed of any conductive materials or composites with a high surface area. Examples of such electrode materials include carbon, carbon nanotubes, graphite, carbon fiber, carbon cloth, carbon aerogel, metallic powders, for example nickel, metal oxides, for example ruthenium oxide, conductive polymers, and any mixtures of any of the above. It should be appreciated that the entire electrodes 125, 127 may be porous and conductive enough so that a substrate is not needed. It should also be appreciated that the substrate may be formed of a non-conductive material that is coated with a conductive coating, such as, for example, platinum, rhodium (Rh), iridium (Ir), or alloys of any of the above metals.

The process of forming the porous portion 131 creates a high surface area, which enables the voltage to be minimized. The ionic species can utilize the high surface area of the porous portion 131. By contacting the porous portion 131 with the ionic electrolyte, the apparent capacitance of the electrodes can be very high when charged. When the porous electrode is charged as a negative electrode, cations in the electrolyte are attracted to the surface of the porous electrode under electrostatic force. The double layer capacitor may be formed by this means. With an enhanced capacitance, the amount of charges that can be charged when the current is applied between the two electrodes 125, 127 also can be enhanced before the voltage on the electrodes reaches the water hydrolysis limit.

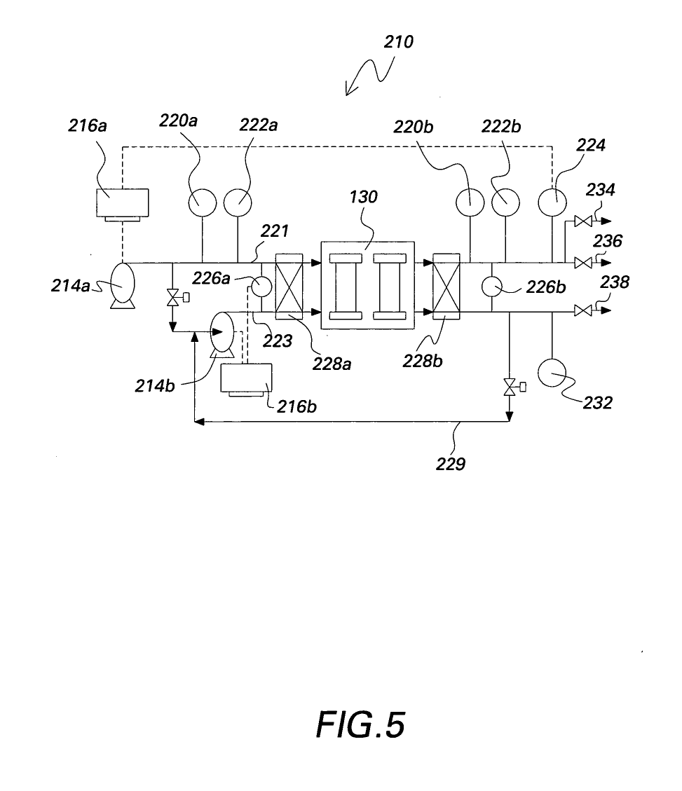

Referring now to FIG. 5, there is shown an ionic species removal system in the form of an EDR system 210 that includes a pair of feed pumps 214_{a, b}, a pair of variable frequency drivers 216_{a, b}, and a pair of reversal valves 228_{a, b} sandwiching a membrane stack 130. The feed pump 214ₐ is utilized to pull saline water from feed tanks (not shown). The pumped saline water is then separated into a pair of stream lines 221, 223. The variable frequency driver 216ₐ controls the speed of the feed pump 214ₐ. The feed pump 214_{b} pumps a portion of the saline water through the stream line 223, and its speed is controlled by the variable frequency driver 216_{b}. A pressure indicator 220ₐ and a conductivity meter 222ₐ are positioned on the stream line 221 upstream of the first reversal valve 228ₐ, while a pressure indicator 220_{b} and a conductivity meter 222_{b} are positioned on the stream line 221 downstream of the second reversal valve 228_{b}. The pressure indicators 220_{a, b} function to measure and control the pressure drop in the stream 221, respectively, upstream and downstream of the membrane stack 130. The conductivity meters 222_{a, b} monitor the conductivity of the water in the stream line 221.

A pressure differential indicator 226ₐ is positioned to monitor a pressure differential between the stream lines 221 and 223 upstream of the membrane stack 130, while a pressure differential indicator 226_{b} is positioned downstream of the membrane stack 130 to monitor a pressure differential between the stream lines 221 and 223. It is important that the pressure differential between the two stream lines 221, 223 be maintained at a certain level to ensure minimal back diffusion.

A flow indicator 224 is positioned to monitor and control the amount of fluid flowing in the stream line 221. A flow indicator 232 is positioned to monitor and control the amount of fluid flowing in the stream line 223. A reflow line 229 extends of from the stream line 223 downstream of the membrane stack 130 and transmits fluid back upstream of the feed pump 214_{b}.

The reversal valves 228_{a, b} allow for periodic reversal of the flows of fluid through the membrane stack 130. Concurrent w/ the reversal of the flows is a reversal of the polarity of the electrodes in the membrane stack 130. Immediately following the reversal of polarity and flow, enough of the product water is dumped until the stack and lines are flushed out, and the desired water quality is restored.

The fluid flowing through the stream line 221 is eventually separated into an off-spec product line 234 and a product line 236, while the fluid flowing through the stream line 223 and reversal valve 228_{b} partially reflows to the stream line 223 through reflow line 229 and pump 214_{b} and the other part exits the system 210 as concentrate in a concentrate blow down line 238. For the stream line 221, the separation into the off-spec product line 234 and product line 236 is controlled by the conductivity meter 222_{b}. The stream line 221 switches to the product line 236 when the conductivity of the outflow is within the product specification, otherwise it switches to the off-spec line 234. For the stream line 223, it will separate into the reflow line 229 and the blow down line 238. The flow ratio for the above two lines is determined by the preset water recovery. A smaller blow down flow is used at higher water recovery and vice versa.

It should be appreciated that the ED system 110 and the EDR system 210 do not include degassifiers. Faraday-based reactions are not utilized in the ED system 110 and the EDR system 210, but instead non-Faraday processes are utilized. The electrostatic nature of the non-Faraday processes means no formation of gasses to be removed with degassifiers in the ED system 110 and the EDR system 210. Further, the membranes in the membrane stack 130 likely will require less cleaning procedures and have a longer effective life than membranes in known ED and EDR systems.

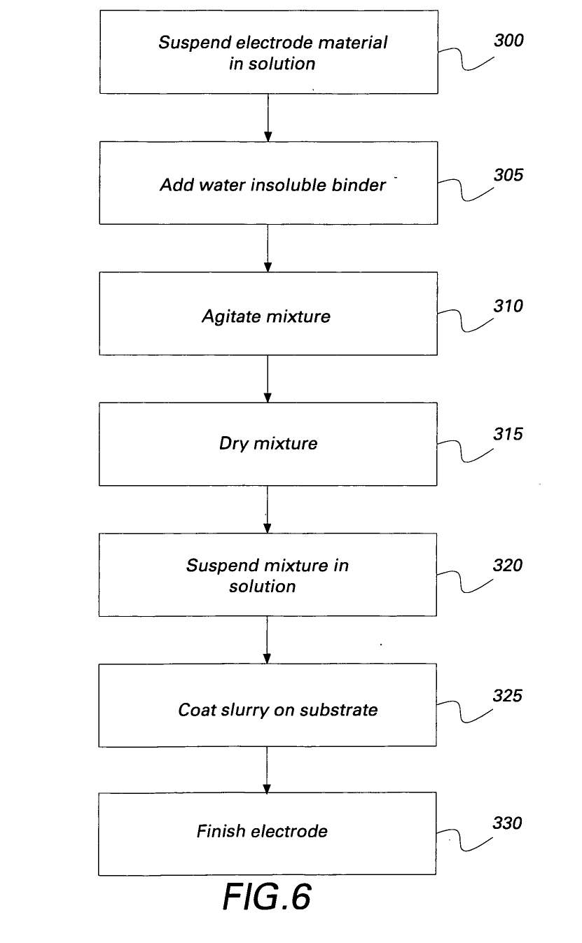

Referring now to FIG. 6, next will be discussed process steps for forming a porous electrode, such as electrodes 125, 127. At Step 300, a portion of an electrode material is suspended in water. For an electrode area of 1.5 centimeters by 1.5 centimeters (2.25 cm²), approximately 22.5 to 2250 milligrams of electrode material should be used. Next, at Step 305 a water-insoluble binder, for example a fluoride polymer, such as, for example, polytetrafluoroethylene (PTFE) or polyvinyldifluoroethylene (PVDF) is added. In one embodiment, PTFE is added in an amount of between 6 and 8 weight percent. In one aspect, PTFE may be added as 20-60% of an aqueous emulsion. It should be appreciated that the water insoluble binder may be added with a stir. At Step 310, further agitation is performed until an evenly distributed paste is formed. At Step 315, the mixture is dried. In one embodiment, the mixture is dried at an elevated temperature, such as, for example, 100° C. Then, at Step 320, the mixture is suspended in ethanol to form a slurry. It should be appreciated that instead of ethanol, the mixture can be suspended in DI-water, an alcohol-based liquid, or an aqueous-ethanol solution. The slurry is then coated on a current collector or substrate, such as substrate 129, and dried in air to form an electrode having a porous portion contiguous with an electrically conductive substrate at Step 325. The electrode then may be pressed at an elevated pressure and dried at an elevated temperature to result in a finished electrode at Step 330. An example of the elevated pressure is between 8 and 15 mega Pascal, and an example of the elevated temperature is about 80° C. Through this process, the finished electrode, such as electrodes 125, 127, are formed to be high surface area electrodes. In one embodiment, the surface area of the electrode material may be in a range of 10-10000 m²/g.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. For example, while embodiments of the invention have been directed toward a desalination system, it should be appreciated that embodiments of the invention are applicable to a general process in which ionic species are removed out of fluid, such as water purification, waste water treatment, mineral removal, etc. Applicable industries include but are not limited to water and processes, pharmaceuticals, and food and beverage industries. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. An ionic species removal system, comprising:
a power supply;
a pump for transporting a liquid through the system; and
a plurality of porous electrodes, each comprising an electrically conductive porous portion.

2. The system of claim 1, wherein said porous electrodes are configured to remove ionic species from the liquid through non-Faraday processes.

3. The system of claim 1, wherein said system is an electrodialysis reversal system.

4. The system of claim 1, wherein said system is an electrodialysis system.

5. The system of claim 4, comprising a dilute stream line and a concentrate stream line for transporting, respectively, pre-filtered dilute and concentrated portions through said plurality of porous electrodes.

6. The system of claim 1, wherein the surface area of each of said porous portions is in a range of 10-10000 m²/g.

7. The system of claim 1, further comprising a substrate contiguous with said porous portion and wherein said substrate is one from the group consisting of a plate, a mesh, a foil, and a sheet.

8. The system of claim 7, wherein said substrate is formed of a material from the group consisting of stainless steel, graphite, titanium, and conductive plastic.

9. The system of claim 8, wherein said substrate is formed of a non-conductive material that is coated with a conductive coating.

10. The system of claim 9, wherein said conductive coating comprises platinum, rhodium, iridium, or alloys thereof.

11. The system of claim 1, wherein said porous portion comprises an electrode material selected from the group consisting of carbon, carbon nanotubes, graphite, carbon fiber, carbon cloth, carbon aerogel, metallic powders, metal oxides, conductive polymers, and any combinations thereof.

12. The system of claim 1, wherein said power supply is a DC power supply, an AC power supply, a DC power supply having a pulsed current with a short duration, or an AC power supply having a pulsed current with a short duration.

13. The system of claim 1, wherein the system is configured for use in water purification, wastewater treatment, mineral removal, pharmaceutical, and food and beverage processes.

14. A method for forming a porous electrode, comprising:
forming a slurry comprising electrode materials; and
coating the slurry on a substrate.

15. The method of claim 14, wherein said forming comprises forming a slurry comprising electrode materials selected from the group consisting of carbon, carbon nanotubes, graphite, carbon fiber, carbon cloth, carbon aerogel, metallic powders, metal oxides, conductive polymers, and any combinations thereof.

16. The method of claim 14, wherein said forming comprises:
suspending an electrode material paste in a solution;
adding a water insoluble binder to the solution to form a mixture;
agitating the mixture; and
suspending the mixture in a deionized-water solution, an alcohol-based solution, an ethanol solution, or an aqueous-ethanol solution.

17. The method of claim 16, wherein said forming comprises drying the mixture prior to suspending the mixture.

18. The method of claim 16, comprising finishing the electrode.

19. The method of claim 18, wherein said finishing comprises pressing the electrode at an elevated pressure and drying the electrode at an elevated temperature.

20. The method of claim 14, wherein said coating comprises coating the slurry on a substrate formed of a material from the group consisting of stainless steel, graphite, titanium, platinum, iridium, rhodium, and conductive plastic.

21. The method of claim 14, wherein said coating comprises coating the slurry on a substrate in the form of a plate, a mesh, a foil, or a sheet

22. A porous electrode, comprising an electrically conductive porous portion having a surface area in a range of 10-10000 m²/g.

23. The electrode of claim 22, further comprising a substrate contiguous with said porous portion.

24. The electrode of claim 23, wherein said substrate is one from the group consisting of a plate, a mesh, a foil, and a sheet.

25. The electrode of claim 23, wherein said substrate is formed of a material from the group consisting of stainless steel, graphite, titanium, platinum, iridium, rhodium, and conductive plastic.

26. The electrode of claim 23, wherein said substrate is formed of a non-conductive material that is coated with a conductive coating.
